(19) United States
(12) Patent Application Publication
(10) Pub. No.: US 2005/0087395 A1
(43) Pub. Date: Apr. 28, 2005

(54) Two-speed windup drive unit

(76) Inventor: Ryota Morikawa, Saitama (JP)

Correspondence Address: NOTARO AND MICHALOS, 100 DUTCH HILL ROAD, SUITE 110, ORANGEBURG, NY, 10962-2100, US

(21) Appl. No.: 10/972,501

(22) Filed: Oct. 25, 2004

(30) Foreign Application Priority Data
Oct. 28, 2003 (JP) 2003-367684

(51) Int. Cl. F03G 1/00

(52) U.S. Cl. 185/38

(57) ABSTRACT

A two-speed windup drive unit which can automatically switch and output two types of rotations with a spring being used as a power source. Switching gears 16 and 17 which move around one gear 10 in a gear mechanism 2 which transmits output rotations in order to disconnectably connect a constant speed mechanism 3 are provided in a long hole 23 which is arranged at a position crossing a movement trajectory of a switching member 6 which starts a linear movement simultaneously with start of outputting rotations and a position at which a force causing falling toward a pinion of the constant speed mechanism 2 by the gravitational force, the gears 16 and 17 are rapidly moved in a direction along which the gears 16 and 17 mesh with the constant speed mechanism 3 by the gravitational force and a revolving force generated by rotations of the gear 10 so that the constant speed mechanism is connected with the gear mechanism, and the gears 16 and 17 are disconnected from the constant speed mechanism 3 against the gravitational force and the revolving force by the switching member 6 when the gears 16 and 17 have moved by a fixed distance from start of outputting rotations.

### TECHNICAL FIELD

The present invention relates to a drive unit which outputs rotations with a spring (spiral spring) being used as a power source. More particularly, the present invention relates to a two-speed windup drive unit which can automatically switch two types of rotations with different rotating speeds and output switched rotations.

### BACKGROUND OF THE INVENTION

As a conventional two-speed windup drive unit, there has been proposed one such as shown in FIGS. 11 and 12, comprising a drive shaft 104 having a spring (not shown) provided thereto, an output shaft 105, a gear mechanism 102 interposed between these shafts, a constant speed mechanism 103 which puts brake on rotations of the gear mechanism 102 when connected with the gear mechanism 102 in order to obtain rotations with a constant speed, and a switching member 106 which disconnects the constant speed mechanism 103 from the gear mechanism 102 after a fixed time elapses with rotations of the drive shaft 104, wherein two types of rotations are output, i.e., constant speed slow rotations with the constant speed mechanism 103 connected and high speed rotations by which the gear mechanism 102 is freely rotated.

The gear mechanism 102 comprises a winding pinion 107 and a drive gear (which is usually referred to as a first gear) 108 which are integral with the drive shaft 104, a driven pinion 114 fixed to the output shaft 105, a third gear (intermediate gears 110 and 111) which meshes with the pinion 114, a gear 113 which meshes with the intermediate gear 110 at the time of winding up only, a switching gear 109 which transmits rotations to the winding pinion 107, and a second gear (traveling switching gears 112 and 113) which meshes with the drive gear 108 at the time of power spring releasing only and transmits rotations to the intermediate gear 111. Here, the traveling switching gears 112 and 113 and the winding switching gear 109 are gears which mesh or move away for idling depending on a rotating direction of meshing target gears, and they are accommodated in arc-shaped long holes 136 and 137 respectively provided to a gear box, and movably supported.

On the other hand, the constant speed mechanism 103 includes an escapement wheel 118 and an ankle member 119 which oscillates around a shaft 122 when pawls 119a at both ends alternately come into contact with teeth of this escapement wheel 118, and takes rotations from the third intermediate gear 110 by connecting the escapement wheel 118 with a pinion 120 which is on the same shaft as the escapement wheel 118 with the intermediate gear 110 through constant speed traveling switching gears 116 and 117. At this time, the switching gears 116 and 117 are designed to disconnect or connect the gear mechanism 102 and the constant speed mechanism 103 by moving in a long hole 123. The long hole 123 is an arc-shaped hole having a center of curvature at a shaft center of the intermediate gear 110, and formed at a position at which it crosses a movement trajectory of the switching member 106. In FIG. 11, the switching gears 116 and 117 move in the long hole 123 around the intermediate gear 110 against the gravitational force and mesh with the pinion 120 when the intermediate gear 110 rotates in a direction along which rotations are output, and are disconnected from the pinion 120 and thrust for idling when rotating in a direction along which the spring is wound.

The switching member 106 forms a sickle-like shape (¼ circle) including internal teeth 138 which mesh with a pinion 129 which is integral with the drive gear 108, and is provided so as to oscillate around a pin 115 arranged at a corner of the gear box (left corner in FIG. 12) in a range that it meshes with the pinion 129. This switching member 106 disconnects the switching gears 116 and 117 from the pinion 120 by pushing a shaft portion 124 of the switching gears 116 and 117 by using a holding surface 140 at an end thereof, and maintains this state. Further, it inhibits movements of the gears 116 and 117 which try to return to original positions by rotations of the gear 110 in traveling rotations, and prevents these gears from being connected with the constant speed mechanism 103 during traveling rotations. Furthermore, in winding, the gravitational force and rotations (counterclockwise direction in the drawing) of the gear 110 are utilized to move the switching gears 116 and 117 downward in the long hole 123, thereby automatically disconnecting the gear 110 from the constant speed mechanism 103.

According to the two-speed windup drive unit having such a structure, when releasing the spring to output rotations, the gear mechanism 102 meshes with the constant speed mechanism 103 through the switching gears 116 and 117, and the constant speed mechanism 103 put brake on rotations of the gear mechanism 102, thereby outputting slow rotations at a constant speed (slow rotations). Then, when the switching member 106 reaches a movement end, the switching gears 116 and 117 are pushed at this end portion to be separated from the escapement wheel 118, and the constant speed mechanism 103 is disconnected from the gear mechanism 102, thereby subjecting the gear mechanism 102 to free rotations (high speed rotations).

[Patent Reference 1] Japanese Patent Application Laid-open No. 2000-126473

### SUMMARY OF THE INVENTION

In this conventional drive unit, however, when starting traveling rotations, the switching gears 116 and 117 which are separated from the escapement wheel 118 of the constant speed mechanism 103 must be engaged with the escapement wheel 118 against the gravitational force by using a running-up motion alone of the switching gears 116 and 117 in the long hole 123 (revolving of the gear 116 which meshes with the gear 110 with rotations of the gear 110 while rotating) caused by rotations of the gear 110, and there occurs a time lag until the gear mechanism 102 in a traveling mode meshes with the constant speed mechanism 103, resulting in quick traveling without effecting slow start.

Moreover, since the escapement wheel (which is also referred to as a star gear) 118 and the ankle member 119 are arranged by utilizing a space on the inner side of the oscillation trajectory of the switching member 106, the gears 118 and 120 and the ankle member 119 must be reduced in size because of the space. Therefore, the teeth depth must be thereby decreased, the engagement between the escapement wheel 118 and the ankle member 119 becomes shallow and these members enter a meshing state in which they are apt to be disconnected due to irregularities in molding the wheels and members in mass production or molding shrinkage. Accordingly, there is a problem that manufacture is difficult. Additionally, there is another problem that abrasion of the teeth proceeds during use, the engagement becomes unstable or loose and switching between slow traveling and quick traveling gradually becomes unclear.

It is, therefore, an object of the present invention to provide a two-speed windup drive unit which can stably perform slow start with less time lags of connection between a gear mechanism and a constant speed mechanism immediately after starting output of rotations. Further, it is another object of the present invention to provide a two-speed windup drive unit which can realize an engagement state in which the constant speed mechanism is hard to come off. Furthermore, it is still another object of the present invention to provide a two-speed windup drive unit which does not have a problem that switching between slow rotations and quick rotations becomes unclear as used.

To achieve this aim, a two-speed windup drive unit according to the present invention comprises: an output shaft; a spring; a gear mechanism which transmits rotations input from the output shaft to the drive shaft by incorporating a winding switching gear in a winding mode of the spring, and transmits rotations of the drive shaft which rotates by a force of the spring by incorporating a traveling switching gear in a rotation output mode; a constant speed mechanism which puts brake on rotations of the gear mechanism at the time of traveling in order to effect rotations at a constant speed; a constant speed rotation switching gear which connects the constant speed mechanism with the gear mechanism; a switching member drive pinion which rotates upon receiving rotations from the drive shaft; a switching member which meshes with the switching member drive pinion in a fixed range, reciprocates with rotations of the drive shaft, comes into contact with the constant speed rotation switching gear at a movement stroke end in traveling, and disconnects the constant speed rotation switching gear from the constant speed mechanism; and a constant speed rotation switching gear which moves around one gear in the gear mechanism and disconnectably connects the constant speed mechanism, wherein the constant speed rotation switching gear is arranged at a position at which it crosses a movement trajectory of the switching member and a position at which a force which causes falling toward the pinion of the constant mechanism by the gravitational force, the constant speed rotation switching gear is rapidly moved in a direction along which it meshes with the constant speed mechanism by the gravitational force and a revolving force generated by rotations of the gears in the gear mechanism so that the constant speed mechanism is connected with the gear mechanism in the rotation output mode, and the constant speed rotation switching gear is disconnected from the constant speed mechanism against the gravitational force and the revolving force by the switching member when moved by a fixed distance from start of outputting rotations.

Therefore, the connection of the constant speed mechanism to the gear mechanism is rapidly carried out since the gravitational force applied to the constant speed rotation switching gear and a force which is generated by the engagement with a meshing target gear of the gear mechanism and causes revolution around the meshing target gear are combined with each other and movement to the constant speed mechanism side is smoothly effected with less time lags. Moreover, the disconnection of the constant speed mechanism from the gear mechanism is smoothly carried out when the constant speed rotation switching gear is disconnected from the constant speed mechanism against the gravitation force and the force which causes the revolution around the meshing target gear.

As described above, according to the two-speed windup drive unit of the present invention, as to switching by the constant speed rotation switching gear, since the gear is moved by utilizing the gravitational force and the force which causes the revolution involved by gear rotations. of the windup gear mechanism, the gear mechanism and the constant speed gear mechanism can be smoothly connected with each other without time lag, thereby enabling rotations at a slow speed based on constant speed rotations from start of outputting rotations. Therefore, it is possible to provide the windup drive unit by which switching between slow rotations and quick rotations is clear and various changes in action of a toy can be demonstrated. Moreover, the escapement wheel and the ankle member constituting the constant speed mechanism, which are arranged in a space above the output shaft, have no restriction in space, and they can be molded with large gears, thereby increasing a teeth depth. Therefore, the influence of irregularities in molding the wheels and members in mass production or molding shrinkage is small, manufacture can be facilitated, and there is no problem that abrasion of teeth proceeds during use and the engagement becomes unstable or loose.

### BRIEF DESCRIPTION OF THE DRAWINGS

FIG. 1 is a vertical cross-sectional view mainly showing a gear mechanism portion of an embodiment of a two-speed windup drive unit according to the present invention;

FIG. 2 is a developed view showing gear trains of a gear mechanism and a constant speed mechanism of the drive unit when outputting rotations;

FIG. 3 is a developed view showing the gear train of the gear mechanism of the drive unit when winding a spring;

FIG. 4 is a horizontal cross-sectional view illustrating a relationship between a switching member which performs disconnection of the gear mechanism and the constant speed mechanism and a pinion which drives this switching member in the drive unit;

FIG. 5 is an explanatory view showing an embodiment of the constant speed mechanism;

FIG. 6 is an explanatory view illustrating a relationship between a constant speed rotation switching gear and the switching member before switching a speed (slow rotations) in the drive unit;

FIG. 7 is an explanatory view illustrating a relationship between the constant speed rotation switching gear and the switching member after switching a speed (quick rotations) of the drive unit;

FIG. 8A is a side view showing a partition block of the drive unit;

FIG. 8B is a perspective view showing a partition block of the drive unit;

FIG. 9A is a side view showing a female type block of the drive unit;

FIG. 9B is a perspective view showing a female type block of the drive unit;

FIG. 10A is a side view showing a male type block of the drive unit;

FIG. 10B is a perspective view showing a male type block of the drive unit;

FIG. 11 is a cross-sectional view showing an example of a conventional two-speed windup drive unit when winding a spring; and

FIG. 12 is a cross-sectional view showing releasing of a spring in the two-speed windup drive unit depicted in FIG. 11.

### DETAILED DESCRIPTION OF THE INVENTION

A structure of the present invention will now be described in detail hereinafter based on an illustrated best mode.

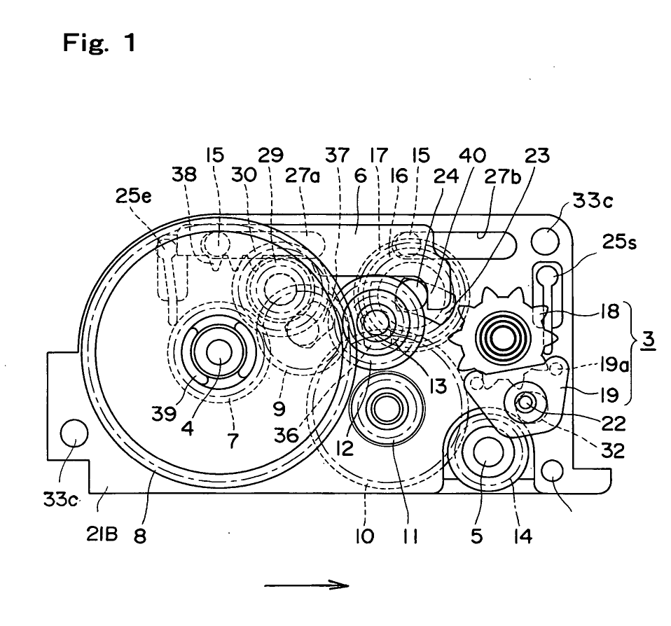

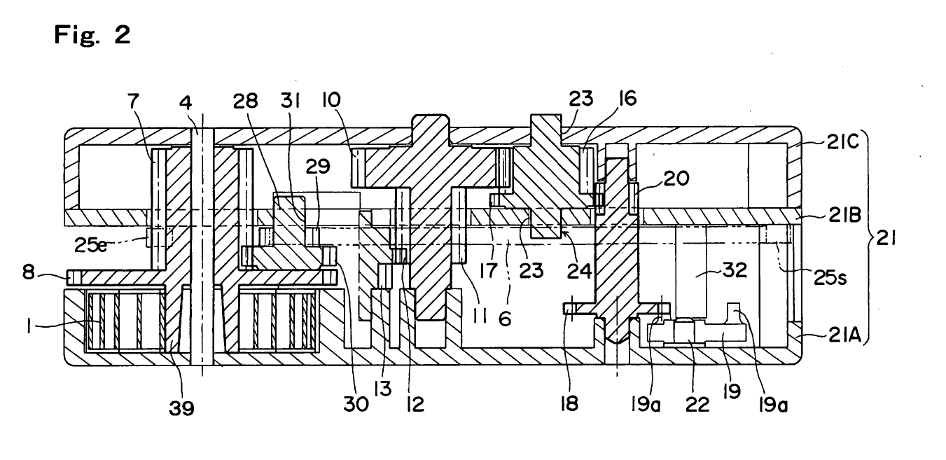

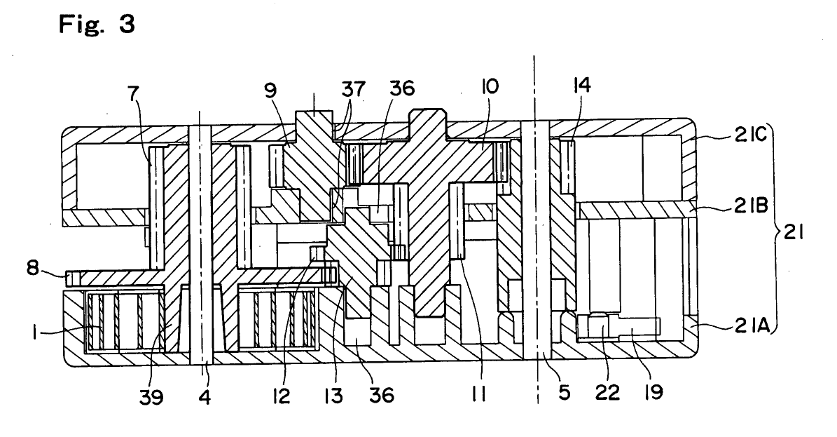

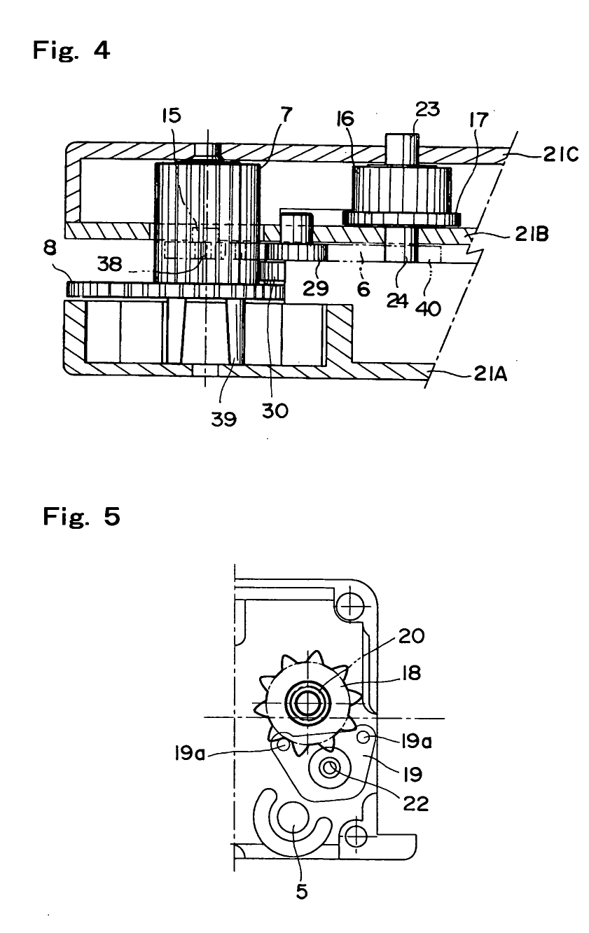

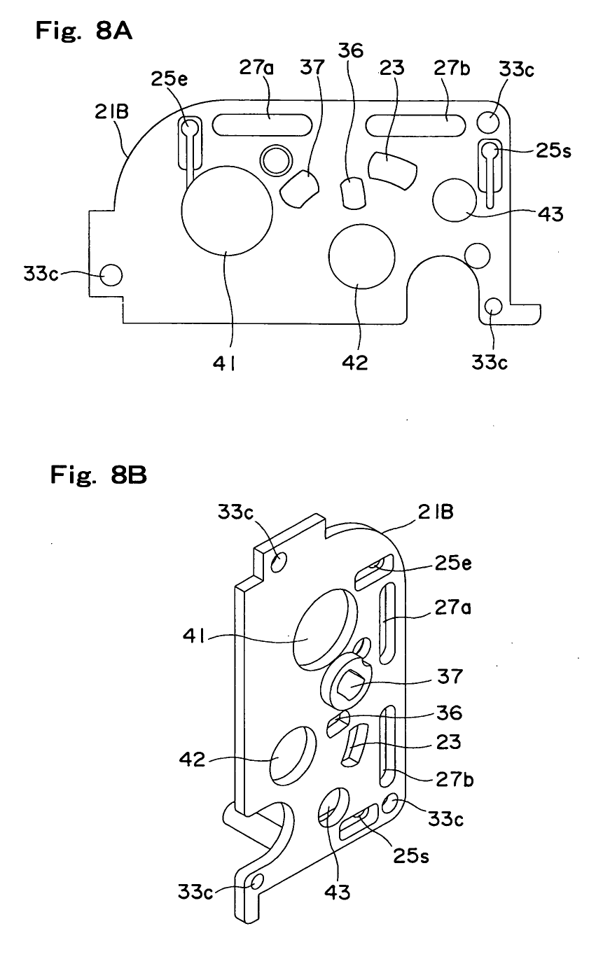

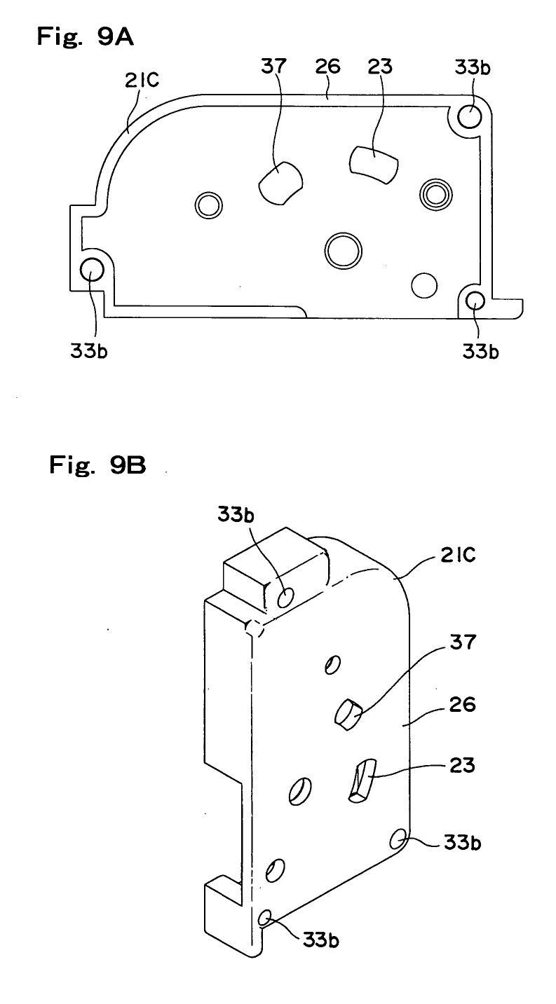

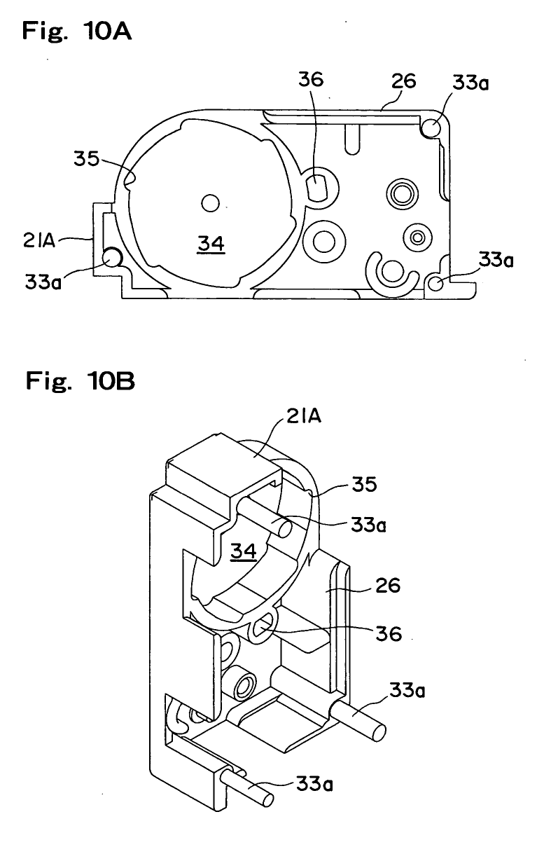

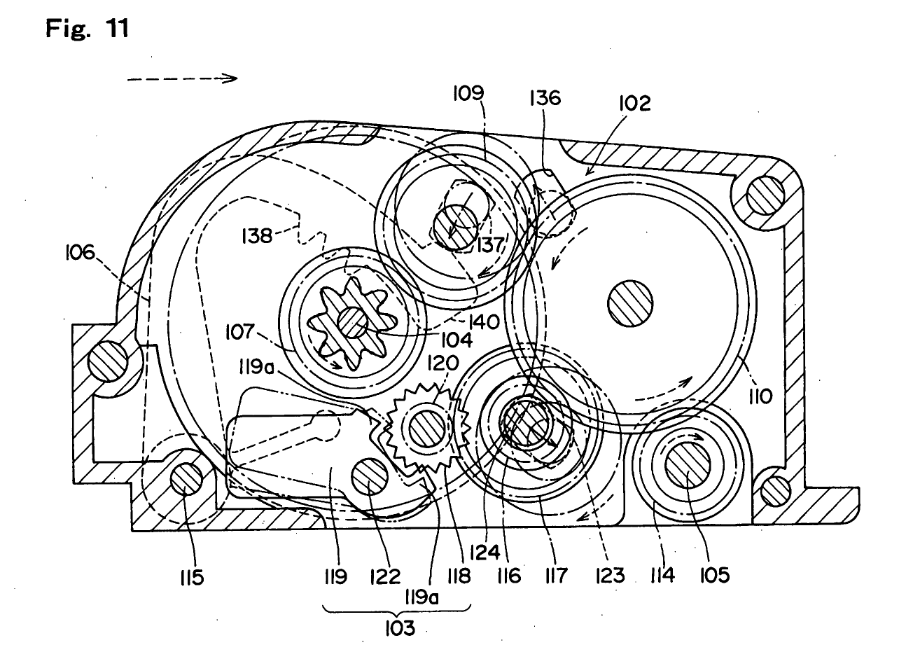

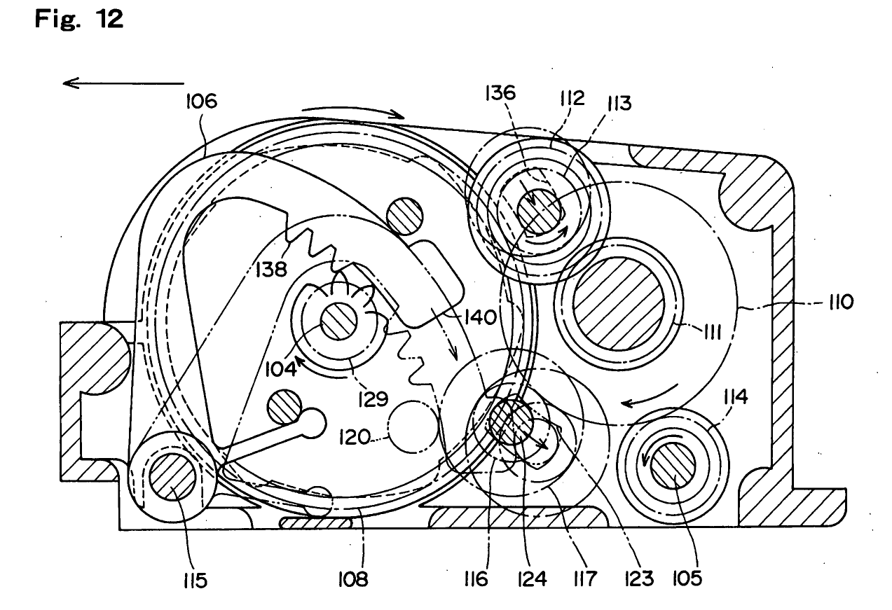

FIGS. 1 to 10 show an embodiment when the present invention is applied to a two-speed windup drive unit for a toy car. This drive unit has a structure in which a spring 1 is used as a drive source and rotations of a drive shaft 4 rotated by the force of this spring 1 are transmitted to an output shaft 5 side through a gear mechanism 2, and comprises a gear mechanism 2 which partially switches constituent gears depending on a rotation output mode and a winding mode and thereby switches a gear ratio, a constant speed mechanism 3 which puts brake on rotations of the gear mechanism 2 in the rotation output mode and allows rotations at a constant speed, constant speed rotation switching gears 16 and 17 which connect the constant speed mechanism 3 with the gear mechanism 2, a switching member drive pinion 29 which rotates upon receiving rotations from the drive shaft 4, and a switching member 6 which meshes with this pinion 29 in a fixed range to reciprocate with rotations of the drive shaft 4, comes into contact with the constant speed rotation switching gears 16 and 17 at a movement stroke end in the rotation output mode, and disconnects the constant speed rotation switching gears 16 and 17 from the constant speed mechanism 3. In the winding mode, rotations input from the output shaft 4 are transmitted to the drive shaft 4 through the gear mechanism 2 including a winding switching gear 9. In the rotation output mode, rotations of the drive shaft 4 which rotates by the force of the power spring 1 are transmitted to the output shaft 5 through the gear mechanism 2 including traveling switching gears 12 and 13, traveling at a constant speed is allowed until the constant speed rotation switching gears 16 and 17 are disconnected from the constant speed mechanism 3 by the switching member 6 from start of traveling rotations. Two types of rotations are output, i.e., constant speed slow rotations (slow traveling) with the constant speed mechanism 3 connected and high speed rotations (quick traveling) with the gear mechanism 2 being freely rotated.

The gear mechanism 2 comprises a winding pinion 7 and drive gear 8 which rotate integrally with the drive shaft 4 having the spring 1 attached thereto, a driven pinion 14 fixed to the output shaft 5, a third gear (intermediate gears 10 and 11 which are target gears in the gear mechanism 2 meshing with the constant speed rotation switching gears 16 and 17) which mesh with the pinion 14, a gear 13 which meshes with the intermediate gear 10 in winding only, a winding switching gear 9 which transmits rotations to the pinion 7, and traveling rotation switching gears 12 and 13 which mesh with the drive gear 8 in spring releasing only and transmit rotations to the intermediate gear 11. This gear device 2 constitutes a winding gear train which transmits rotations to the output shaft 5, the driven pinion 14, the intermediate gear 10, the winding switching gear 9, the pinion 7, the drive shaft 4 and the spring 1 in the mentioned order when winding the spring 1. Further, when releasing the spring 1, the gear device 2 constitutes a traveling gear train which transmits rotations to the spring 1, the drive shaft 4, the drive gear 8, the traveling switching gear 13, the traveling switching gear 12, the intermediate gear 11, the intermediate gear 10, the driven pinion 14 and the output shaft 5 in the mentioned order.

Here, the gears are usually called a “first gear”, a “second gear” and a “third gear” from the side close to the drive shaft 4 in the rotation output mode. In this embodiment, the drive gear 8 (including the pinion 7 which is coaxially arranged with the drive gear 8 and is integral with this gear) is called the first gear, the traveling switching gear 13 (including the gear 12 which is coaxially arranged with the gear 13 and is integral with this gear) is called the second gear and the intermediate gear 11 (including the gear 10 which is coaxially arranged with the gear 11 and is integral with this gear) is called the third gear. It is to be noted that the intermediate gears 10 and 11 constituting the third gear and the winding switching gear 9, and the drive gear 8 and the pinion 7 constituting the first gear are molded integrally with respective shafts by using plastic such as polyacetal. Furthermore, the third gear as the meshing target gear 10 in the gear mechanism 2 from which the constant speed rotation switching gears 16 and 17 obtain rotations is arranged on a line connecting the drive shaft 4 with the output shaft 5.

Moreover, the traveling rotation switching gears 12 and 13 (second gear) and the winding switching gear 9 are gears which are incorporated into or disconnected from the gear mechanism 2 depending on rotating directions of meshing target gears, and they are accommodated in arc-shaped long holes 36 and 37 respectively provided to a male type block 21A, a partition block 21B, a female type block 21C and a partition block 21B and movably supported in the long holes 36 and 37. The long hole 36 which supports the traveling rotation switching gears 12 and 13 forms an arc shape having the same center of curvature as a rotational center of the drive gear 8 (i.e., a center of the drive shaft 4) and supports the traveling.rotation switching gears 12 and 13 to move (revolution) around the drive gear 8. The long hole 37 which supports the winding switching gear 9 forms an arc shape having the same center of curvature as a rotational center of the intermediate gear 10 constituting the third gear, and supports the winding switching gear 9 to move (revolution) around the intermediate gear 10.

The drive gear 8 and the pinion 7 are integrally molded with a bifurcated spring attachment portion 39 which is used to attach an end portion on the inner side of the spring by utilizing plastic. Moreover, they are integrated with the metallic drive shaft 4 by press fitting.

In this embodiment, the pinion 29 which drives the switching member 6 is a member which is different from the drive shaft 4, and set apart from this drive shaft 4. A pinion 30 is provided on the same shaft as the pinion 29, and the pinion 30 is engaged with the pinion 7 integrated with the drive shaft 4 and arranged at a position close to a ceiling 26 of a gear box 21. In this embodiment, a shaft portion 31 is fitted in a hole 28 provided to the partition block 21B of the gear box 21 and supported in a cantilever manner, and it is also supported by engaging the pinion 30 with the pinion 7.

The constant speed mechanism 3 is arranged above the output shaft 5. In this embodiment, the constant speed mechanism 3 comprises an escapement formed of an escapement wheel 18 and an ankle member 19 which oscillates when pawls 19a and 19a at both ends of the ankle member 19 alternately come into contact with teeth of this escapement wheel 18, and the pinion 20 on the same axis as the escapement wheel's is engaged with the intermediate gear 10 of the gear mechanism 2 through the constant speed rotation switching gears 16 and 17. The ankle member 19 is rotatably fitted to a pin 22 which protrudes from a wall surface of the male type block 21A, and prevented from coming off by a presser pin 32 which protrudes from a wall surface of the partition block 21B, thereby being supported so as to be capable of oscillating.

The constant speed rotation switching gears 16 and 17 are supported by an arc-shaped long hole 23 provided to the partition block 21B and the male type block 21C, and achieve disconnection or connection of the gear mechanism 2 and the constant speed mechanism 3 by moving in the long hole 23. The long hole 23 is an arc-shaped hole having the same center of curvature as a rotational center of the intermediate gear 10 constituting the meshing target gear in the gear mechanism 2 with which the constant speed rotation switching gears 16 and 17 are engaged, i.e., the third gear, and arranged at a position between the meshing target gear 10 and the switching member 6 at which the force which causes falling toward the pinion 20 of the constant speed mechanism 3 is generated by the gravitational force, and the constant speed rotation switching gears 16 and 17 are supported in such a manner that they rotate around the meshing target gear 10 from which rotations are obtained and can move in a direction along which they mesh with the constant speed mechanism 3 by the gravitational force and the force which causes revolution generated by rotations of the meshing target gear 10 in a rotation output mode. That is, in this embodiment, the constant speed rotation switching gears 16 and 17 and the long hole 23 which supports those gears are arranged in a first quadrant in an orthogonal coordinate running through the center of the meshing target gear 10 in FIG. 1. Additionally, the constant speed rotation switching gears 16 and 17 are arranged between the switching member 10 and the meshing target gear 10 of the gear mechanism 2.

The constant speed rotation switching gears 16 and 17 are molded integrally with the shaft portion 24 by using plastic, e.g., polyacetal, and provided in such a manner that the gear 16 meshes with the intermediate gear 10 and the gear 17 meshes with the pinion 20. The constant speed rotation switching gears 16 and 17 mesh with the intermediate gear 10 and the pinion 20 when the intermediate gear 10 rotates in a rotation output direction (clockwise direction in FIG. 1), and they are thrust for idling when the intermediate gear 10 rotates in a winding direction (counterclockwise direction in FIG. 1).

The switching member 6 has a rack 38 which meshes with a pinion 29 in a fixed range, is guided by guide holes 27a and 27b in a range that it meshes with the pinion 29 by rotations of the pinion 29, i.e., rotations of the drive shaft 4 by the spring 1, and performs a reciprocating linear motion. The switching member 6 has guide pins 15 provided on the front and rear sides thereof, and is supported by the partition block 21B slidably in a longitudinal direction along the inner wall of the ceiling 26 of the gear box 21 when the guide holes 27a and 27b formed of long holes, which are provided to the partition block 21B and whose long axes are arranged in the longitudinal direction, are engaged with the guide pins 15.

Further, springs 25s and 25e which constantly give impetus to push back the switching member 6 toward the opposite side are provided at stroke ends of the switching member 6. These springs 25s and 25e are leaf springs with a matchstick-like shape and are integrally formed on the wall surface of the partition block 21B formed of plastic, and push the switching member 6 in such a manner that rack 38 smoothly mesh with the pinion 29 when the end portion of the rack 38 of the switching member 6 is not disconnected from the pinion 29 and the pinion 29 rotates in a meshing direction.

The switching member 6 is accommodated between the partition block 21B and the male type block 21A and supported slidably in the longitudinal direction with the guide pins 15 being fitted in the guide holes 27a and 27b of the partition block 21B. A holding surface 40 which comes into contact with the shaft portion 24 of the constant speed rotation switching gears 16 and 17 is provided at a rear end of the switching member 6. The holding surface 40 is caught by the shaft portion 24 to separate the gear 16 from the gear 20 with which the gear 16 is engaged, and maintains this state. That is, the switching member 6 which moves simultaneously with start of traveling rotations separates the constant speed rotation switching gears 16 and 17 from the gear 20 of the constant speed mechanism 3 against the gravitational force and the revolving force after a fixed time or a fixed distance passes.

It is to be noted that substantially concentrically arranging the intermediate gear 10, the constant speed rotation switching gears 16 and 17 and the escapement wheel 18 around the gear 10 as shown in FIG. 1 is preferable for saving a space and increasing a size of the escapement wheel 18 and the ankle member 19. Furthermore, the part with which the switching member 6 comes into contact is not restricted to the end of the shaft portion 24, and it is preferable to press the shaft center by the holding surface 40 as much as possible. As a result, it is possible to avoid stop of the movement of the switching member 6 in mid course which is generated due to complications or the like during movement of the constant speed rotation switching gears 16 and 17.

The gear box 21 is assembled by fitting of pins and holes, which are not illustrated, in such a manner that the gear box 21 can be divided into the male type block 21A, the female type block 21C and the partition block 21B which is held between the blocks 21A and 21C. The spring 1 is accommodated between the male type block 21A and the partition block 21B. An outer end portion of the spring 1 is folded back and rounded, and it is fitted and fixed in a groove 35 on the wall surface of a spring accommodation space 34 provided in the male type block 21A. On the other hand, an inner end portion of the spring 1 is fitted and fixed between two protrusions 39 and 39 integrally molded with the drive shaft 4. Therefore, when the spring 1 is excessively wound, the outer end portion of the spring 1 pops out from the engagement groove 35 and moves along the inner wall surface in order to avoid further winding.

According to the two-speed windup drive unit having the above-described structure, rotation outputs on two stages can be obtained in the following manner.

A case in which the drive unit is mounted in a toy, e.g., a toy car is taken as an example. First, when the toy is pulled in a direction (direction indicated by an arrow (→) in FIG. 1) opposite to a traveling direction while being pressed against a floor or the like and the output shaft 5 is rotated in a reverse direction, the winding switching gear 9 meshes with the pinion 7 by rotations of the intermediate gear 10 in a winding direction, and the rotations are transmitted to the drive shaft 4 to which the spring 1 is attached, thereby winding the spring 1. At this time, the constant speed rotation switching gears 16 and 17 move up in the long hole 23 against the gravitational force with rotations of the gear 10 in the winding direction (counterclockwise rotations), and the constant speed mechanism 3 is disconnected. Therefore, the winding gear mechanism 2 is readily wound without receiving a load on the constant speed mechanism 3 side. When the spring 1 is wound by a predetermined quantity, the outer end portion of the spring 1 which is not constrained exits from the groove 35 of the male type block 21A and moves. This movement can be informed by a sound when the end portion of the spring 1 moves into/from the groove 35 Then, the winding operation is stopped.

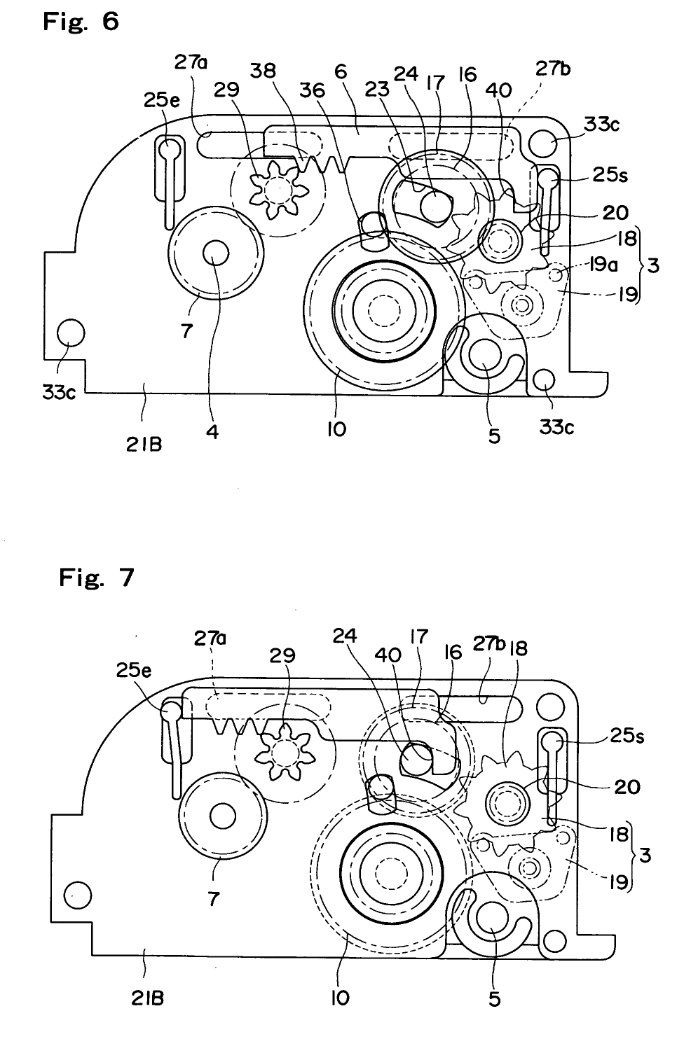

Subsequently, when the toy car is released, the drive shaft 4 rotates in the clockwise direction by the release of the spring 1 as shown in FIG. 6. As a result, the winding switching gear 9 which is being engaged with the pinion 7 is pushed up in the long hole 37 in the rotating direction of the winding pinion and disengaged to be idled, and the traveling switching gear 13 which meshes with the drive gear 8 revolves around the drive gear 8 with the gravitational force while rotating and meshes with the gear 11. Therefore, rotations of the drive shaft 4 are transmitted to the drive gear 8, the traveling switching gear 13, the traveling switching gear 12, the intermediate gear 11, the intermediate gear 10, the driven pinion 14 and the output shaft 5 in the mentioned order, thereby enabling the toy car to travel. At this time, since the constant speed rotation switching gear 16 and the gear 17 having the same shaft, which mesh with the intermediate gear 10 constituting the traveling gear mechanism 2, move while rotating around the intermediate gear 10 in the long hole 23 toward the gravitational force acting direction with rotations of the intermediate gear 10 in the traveling direction (clockwise direction in the drawing), the gear 17 meshes with the gear 20 which is on the same shaft as the escapement wheel 18, and is quickly connected with the constant speed mechanism 3. Therefore, the toy car travels slowly at a constant speed that rotations are controlled by the constant speed mechanism 3.

The rack 38 of the switching member 6 whose tooth surface is pressed against the pinion 29 by the force of the spring 25s mesh with the rotating pinion 29 simultaneously with start of traveling rotations, thereby effecting a linear motion of the switching member 6. Then, when the switching member 6 has moved by a fixed distance or a fixed time has elapsed, the shaft portion 24 of the constant speed rotation switching gears 16 and 17 is pulled on the holding surface 40 of this switching member 6, and the gear 16 is disconnected from the gear 20 while moving against the gravitational force and the force which causes revolution around the intermediate gear 10 by rotations of the intermediate gear 10 (state shown in FIG. 7). Therefore, the gear mechanism 2 freely rotates without braking by the constant speed mechanism 3, and the higher speed rotations/higher speed traveling is effected as compared with constant speed rotations.

It is to be noted that the above embodiment is an example of a preferred embodiment according to the present invention, but the present invention is not restricted thereto, and various modifications can be carried out without departing from the scope of the invention. For example, the constant speed mechanism 3 is not restricted to one utilizing the above-described ankle member 19. For example, although not shown, it is possible to adopt a constant speed mechanism comprising a rubber brake which is expanded by a centrifugal force at the time of rotations and a cylindrical frame in which this brake is accommodated. In this constant speed mechanism, rotations of the brake are braked by frictions between the brake and the inner peripheral surface of the cylindrical frame. In this case, a pinion is provided to the brake, and the gear mechanism 2 is connected through the constant speed rotation switching gear 16 and the coaxial gear 17. Further, although not shown, it is also possible to utilize a constant speed mechanism using a rotating pendulum.

### Industrial Applicability

The two-speed windup drive unit according to the present invention can be utilized as a drive source which outputs two types of rotations, i.e., constant speed slow rotations (slow traveling) and high speed rotations (quick traveling) by which the gear mechanism is freely rotated as a drive source for a toy car, or obtains a motion at a constant slow speed and a motion at a non-fixed high speed in, e.g., a doll.

1. A two-speed windup drive unit comprising: an output shaft; a spring; a gear mechanism which transmits rotations input from the output shaft to the drive shaft by incorporating a winding switching gear in a winding mode of the spring, and transmits rotations of the drive shaft which rotates by a force of the spring by incorporating a traveling switching gear in a rotation output mode; a constant speed mechanism which puts brake on rotations of the gear mechanism at a time of traveling in order to effect rotations at a constant speed; a constant speed rotation switching gear which connects the constant speed mechanism with the gear mechanism; a switching member drive pinion which rotates upon receiving rotations from the drive shaft; a switching member which meshes with the switching member drive pinion in a fixed range, reciprocates with rotations of the drive shaft, comes into contact with the constant speed rotation switching gear at a movement stroke end at the time of traveling, and disconnects the constant speed rotation switching gear from the constant speed mechanism; and a constant speed rotation switching gear which moves around one gear in the gear mechanism and disconnectably connects the constant speed mechanism, wherein the constant speed rotation switching gear is arranged at a position at which the constant speed rotation switching gear crosses a movement trajectory of the switching member and a position at which a force which causes falling toward a pinion of the constant speed mechanism by gravitational force, the constant speed rotation switching gear is rapidly moved in a direction along which it meshes with the constant speed mechanism by the gravitational force and a revolving force generated by rotations of the gears in the gear mechanism so that the constant speed mechanism is connected with the gear mechanism in the rotation output mode, and the constant speed rotation switching gear is disconnected from the constant speed mechanism against the gravitational force and the revolving force by the switching member when moved by a fixed distance from start of outputting rotations.

2. The two-speed windup drive unit according to claim 1, wherein the constant speed mechanism comprises an escapement wheel and an ankle member, and is arranged together with the constant speed rotation switching gear around a meshing target gear of the gear mechanism which meshes with the constant speed rotation switching gear.

3. The two-speed windup drive unit according to claim 1, wherein the switching member comes into contact with resin springs provided on a gear box side at both stroke ends thereof, and is constantly pressed toward a switching member drive pinion by forces of the resin springs.

4. The two-speed windup drive unit according to claim 1, wherein the switching member drive pinion meshes with a winding pinion of the drive shaft and is provided apart from the drive shaft.
